(19) United States
(12) Patent Application Publication
(10) Pub. No.: US 2009/0060615 A1
(43) Pub. Date: Mar. 5, 2009

(54) IMAGE FORMING APPARATUS, CONTROL METHOD FOR CONTROLLING THE IMAGE FORMING APPARATUS, AND COMPUTER READABLE MEDIUM

(75) Inventor: Yuichi Hosoda, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/198,624

(22) Filed: Aug. 26, 2008

(30) Foreign Application Priority Data
Aug. 31, 2007 (JP) 2007-226334

(51) Int. Cl. G03G 15/22

(52) U.S. Cl. 399/400

(57) ABSTRACT

A control method for controlling an image forming apparatus includes fixing recording material on a sheet; conveying, by a conveying unit, the sheet on which the recording material is fixed; and controlling the conveying unit such that the conveying unit reciprocates the sheet on a conveying path along which the sheet is conveyed.

### BACKGROUND OF THE INVENTION

1. Field of the Invention

The present invention relates to an image forming apparatus, a control method for controlling the image forming apparatus, and a computer readable medium.

2. Description of the Related Art

In a known image forming apparatus where recording material such as toner is thermally fixed to a plurality of sheets, toner on sheets stacked in an ejection unit is fused due to an increase in sheet temperature caused by thermal fixing, and thus, the sheets stick to each other.

As a solution to this, there is proposed an image forming apparatus in which a cooling fan is provided near an ejection unit. In this image forming apparatus, the cooling fan blows air to sheets ejected on the ejection unit so as to cool the ejected sheets (Japanese Patent Laid-Open No. 2002-072729).

However, adding the cooling fan causes an increase in size and cost of the image forming apparatus.

### SUMMARY OF THE INVENTION

It is desirable to provide an image forming apparatus and a control method for controlling the image forming apparatus which overcome one or more of the above-described problems.

According to an aspect of the present invention, an image forming apparatus includes a fixing unit configured to fix recording material on a sheet, a conveying unit configured to convey the sheet on which the recording material is fixed by the fixing unit, and a control unit configured to control the conveying unit such that the conveying unit reciprocates the sheet on a conveying path along which the sheet is conveyed.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principle of the invention.

FIG. 1 illustrates an example configuration of an image forming system to be controlled according to an embodiment of the present invention.

FIG. 2 is a block diagram illustrating an example configuration of a printer controller according to an embodiment of the present invention.

FIG. 3 is a block diagram illustrating an example configuration of a printer engine and a post-processing unit according to an embodiment of the present invention.

FIG. 4 is a cross-sectional view illustrating an example configuration of a printer and the post-processing unit according to an embodiment of the present invention.

FIG. 5 is a cross-sectional view illustrating an example configuration of the post-processing unit according to an embodiment of the present invention.

FIG. 6 illustrates a sheet as viewed from above the post-processing unit, the sheet being conveyed upward in the drawing.

FIG. 7 illustrates a sheet as viewed from above the post-processing unit, the sheet being conveyed upward in the drawing.

FIG. 8 illustrates a sheet as viewed from above the post-processing unit, the sheet being conveyed upward in the drawing.

FIG. 9 is a schematic view illustrating a control procedure according to an embodiment of the present invention.

FIG. 10 illustrates an information table to be controlled according to an embodiment of the present invention.

FIG. 11 is a flowchart illustrating a control procedure according to an embodiment of the present invention.

FIG. 12 is a flowchart illustrating a control procedure according to an embodiment of the present invention.

FIG. 13 is a flowchart illustrating a control procedure according to an embodiment of the present invention.

FIG. 14 is a flowchart illustrating a control procedure according to an embodiment of the present invention.

FIG. 15 is a flowchart illustrating a control procedure according to an embodiment of the present invention.

FIG. 16 is a flowchart illustrating a control procedure according to an embodiment of the present invention.

FIG. 17 is a flowchart illustrating a control procedure according to an embodiment of the present invention.

FIG. 18 is a flowchart illustrating a control procedure according to an embodiment of the present invention.

FIG. 19 illustrates program code groups according to an embodiment of the present invention.

### DESCRIPTION OF THE EMBODIMENTS

### First Exemplary Embodiment

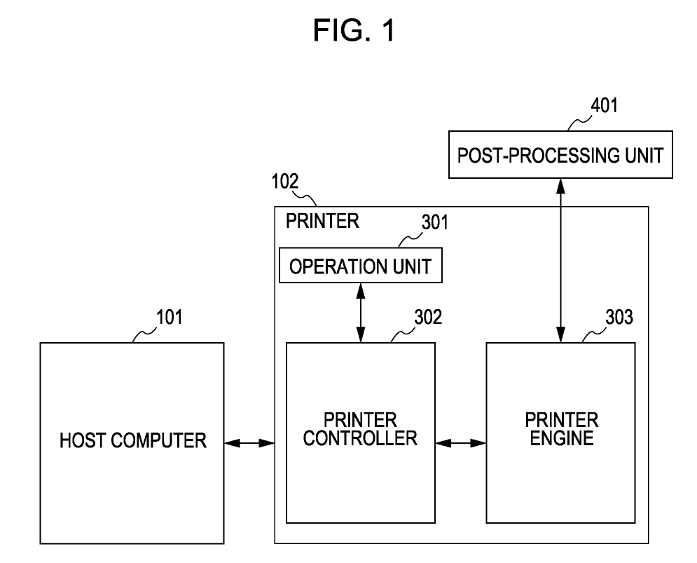

FIG. 1 illustrates a configuration of an image forming system according to an embodiment of the present invention.

A host computer 101 serving as an information processing apparatus is connected to a printer 102. The host computer 101 supplies print data to the printer 102 via a communication line, such as a network. Additionally, the host computer 101 transmits a control signal for controlling the printer 102.

The printer 102 serving as an image forming apparatus receives print data from the host computer 101 and performs printing of the print data received.

An operation unit 301 serves as a user interface, through which the printer 102 receives an instruction from a user. A printer controller 302 generates bitmap data on the basis of print data received from the host computer 101, and transmits the generated bitmap data to a printer engine 303. The printer engine 303 performs printing on the basis of the bitmap data transmitted from the printer controller 302.

A post-processing unit 401 performs post-processing, such as stapling, on sheets printed by the printer engine 303.

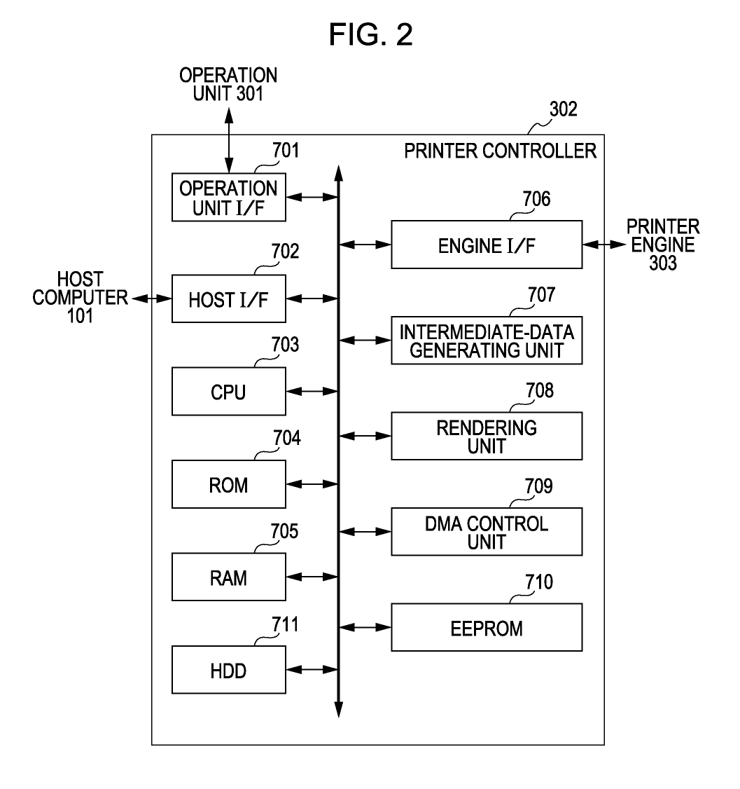

FIG. 2 is a block diagram illustrating a configuration of the printer controller 302 of the printer 102.

A central processing unit (CPU) 703 executes a program stored in a read-only memory (ROM) 704 to control an overall operation of the printer 102. For example, the CPU 703 receives a print instruction from the operation unit 301 via an operation unit interface (I/F) 701, and then controls the printer 102 according to the print instruction received. Also, the CPU 703 controls the printer 102 according to a print instruction, print data, and a control signal received from the host computer 101 via a host I/F 702.

The ROM 704 stores control programs to be executed by the CPU 703 for performing various processes, including those illustrated by flowcharts to be described in the present embodiment.

A random-access memory (RAM) 705 serves as a work area for the host computer 101. The RAM 705 stores print data received from the host computer 101. The RAM 705 also stores intermediate data generated by an intermediate-data generating unit 707 and bitmap data rendered by a rendering unit 708.

An electrically erasable programmable ROM (EEPROM) 710 is, for example, a non-volatile memory. The EEPROM 710 holds control information, such as a print-density correction table, to be used by the CPU 703.

The intermediate-data generating unit 707 generates intermediate data on the basis of print data received from the host computer 101.

The rendering unit 708 generates bitmap data from intermediate data generated by the intermediate-data generating unit 707.

In response to an instruction from the CPU 703, a direct memory access (DMA) control unit 709 transmits, via an engine I/F 706 to the printer engine 303, bitmap data stored in the RAM 705 and to be printed.

A hard disk drive (HDD) 711 can store bitmap data rendered by the rendering unit 708. In response to an instruction from the user, the CPU 703 transmits bitmap data stored in the HDD 711 to the printer engine 303, thereby causing the printer engine 303 to print the bitmap data.

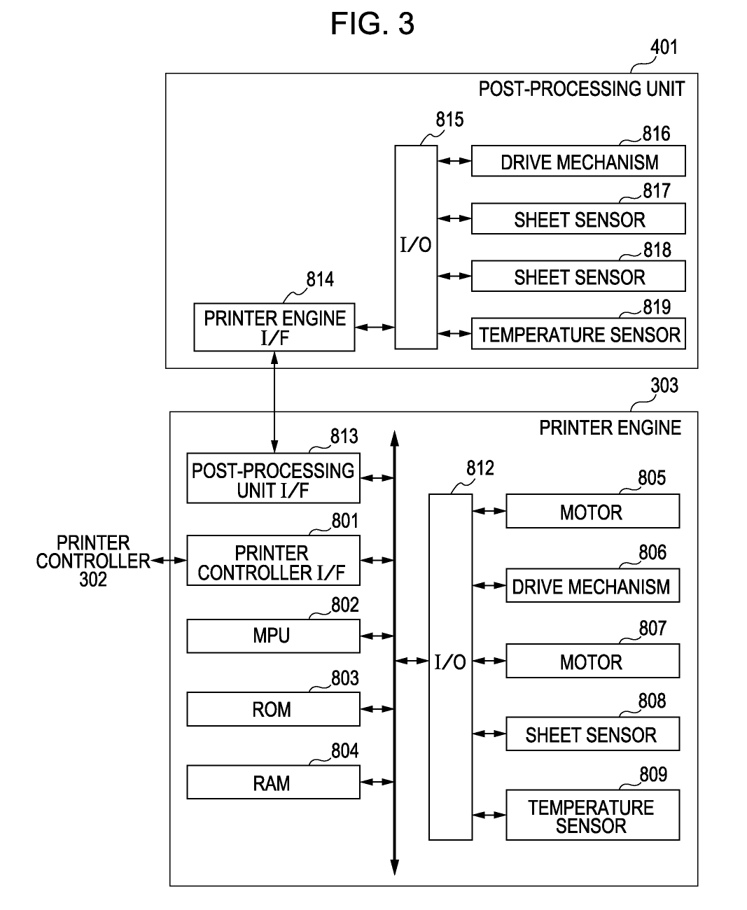

FIG. 3 is a block diagram illustrating a configuration of the printer engine 303 and the post-processing unit 401.

A microprocessing unit (MPU) 802 controls individual motors and image forming units, according to an instruction received from the CPU 703 of the printer controller 302 via a printer controller I/F 801.

A ROM 803 stores various control programs to be executed by the MPU 802.

A RAM 804 serves as a work area which allows the MPU 802 to execute various control programs.

The MPU 802 controls motors 805 and 807 and a drive mechanism 806 via an input/output (I/O) port 812. The MPU 802 always monitors, via the I/O port 812, the presence of a signal from a sheet sensor 808 and a temperature sensor 809.

The motor 805 rotates rollers of the printer 102 to feed and convey a sheet from a feeding unit. The motor 805 also rotates rollers of the post-processing unit 401 to eject a sheet conveyed to the post-processing unit 401. The drive mechanism 806 is a mechanism for conveying a sheet. The motor 807 causes drums of the image forming units and an intermediate transfer member to operate. The two motors 805 and 807 described in this example may be replaced with a single motor.

The sheet sensor 808 is provided in a conveying path (conveying unit) of the printer 102 and detects passage of a sheet along the conveying path.

The temperature sensor 809 is provided, for example, near a sheet output tray of the printer 102 to detect a temperature near the sheet output tray. Alternatively, the temperature sensor 809 may be provided, for example, near a fixing device to detect a temperature near the fixing device.

The MPU 802 controls the post-processing unit 401 via a post-processing unit I/F 813 according to an instruction from the CPU 703.

The post-processing unit 401 includes a drive mechanism 816. The MPU 802 controls the drive mechanism 816 of the post-processing unit 401 via a post-processing unit I/F 813 included in the printer engine 303, a printer engine I/F 814 included in the post-processing unit 401 and an I/O port 815 included in the post-processing unit 401.

The MPU 802 of the printer engine 303 always monitors the presence of a signal from a sheet sensor 817 and a sheet sensor 818 via the I/O port 812. As described in detail below, the sheet sensor 817 detects a sheet conveyed to the post-processing unit 401, while the sheet sensor 818 detects whether there is a sheet on a bundle tray of the post-processing unit 401. A temperature sensor 819 is provided near an ejection unit of the post-processing unit 401. The MPU 802 monitors a signal from the temperature sensor 819 to detect a temperature near the ejection unit.

Although the temperature sensor 819 is provided near the ejection unit in this example, the temperature near the ejection unit may be predicted from a value of a temperature sensor near the fixing device.

Although the post-processing unit 401 is connected to the printer engine 303 in the present embodiment, the post-processing unit 401 may be connected to the printer controller 302 so as to operate according to an instruction from the CPU 703. The post-processing unit 401 may include an MPU (not shown) which controls or monitors the drive mechanism 816, the sheet sensors 817 and 818, and the temperature sensor 819 according to an instruction from the MPU 802 or the CPU 703.

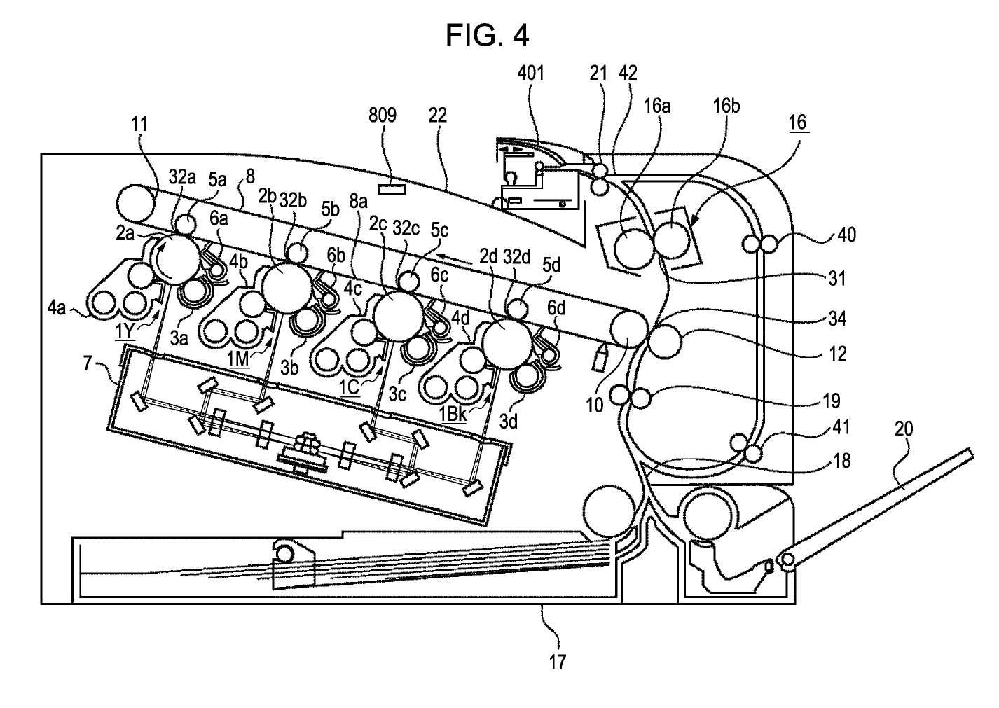

FIG. 4 illustrates a configuration of the printer 102 serving as an image forming apparatus according to an embodiment of the present invention.

The printer 102 includes four image forming units: an image forming unit 1Y for forming a yellow image, an image forming unit 1M for forming a magenta image, an image forming unit 1C for forming a cyan image, and an image forming unit 1Bk for forming a black image. These four image forming units 1Y, 1M, 1C, and 1Bk are arranged in line at regular intervals.

The image forming units 1Y, 1M, 1C, and 1Bk include respective drum-type electrophotographic photosensitive members (hereinafter referred to as photosensitive drums) 2a, 2b, 2c, and 2d serving as image bearing members.

The photosensitive drums 2a, 2b, 2c, and 2d are surrounded by respective primary chargers 3a, 3b, 3c, and 3d; developing devices 4a, 4b, 4c, and 4d; transfer rollers 5a, 5b, 5c, and 5d serving as transfer devices; and drum cleaners 6a, 6b, 6c, and 6d.

A laser exposure unit 7 is disposed below the primary chargers 3a, 3b, 3c, and 3d and the developing devices 4a, 4b, 4c, and 4d.

The developing devices 4a, 4b, 4c, and 4d contain recording materials, such as a yellow toner, a magenta toner, a cyan toner, and a black toner, respectively.

The photosensitive drums 2a, 2b, 2c, and 2d are negatively-charged organic photoconductor (OPC) photosensitive members having respective photoconductive layers on aluminum drum bases. A drive unit (not shown) rotates to drive the photosensitive drums 2a, 2b, 2c, and 2d clockwise in FIG. 4 at a predetermined processing speed.

The primary chargers 3a, 3b, 3c, and 3d serving as primary charging devices uniformly charge the surfaces of the respective photosensitive drums 2a, 2b, 2c, and 2d to predetermined negative potentials with a charging bias applied from a charging bias power source (not shown).

The developing devices 4a, 4b, 4c, and 4d containing toners cause the toners of respective colors to adhere to electrostatic latent images formed on the respective photosensitive drums 2a, 2b, 2c, and 2d, thereby developing the electrostatic latent images into toner images (visible images).

The transfer rollers 5a, 5b, 5c, and 5d serving as primary transfer devices are arranged such that they can be brought into contact with the respective photosensitive drums 2a, 2b, 2c, and 2d at respective primary transfer points 32a, 32b, 32c, and 32d, with an intermediate transfer belt 8 serving as a transfer unit interposed between the transfer rollers 5a, 5b, 5c, and 5d and the photosensitive drums 2a, 2b, 2c, and 2d.

The drum cleaners 6a, 6b, 6c, and 6d include respective cleaning blades for removing, from their corresponding photosensitive drums 2a, 2b, 2c, and 2d, residual toners remaining thereon after primary transfer.

The intermediate transfer belt 8 on the upper side of the photosensitive drums 2a, 2b, 2c, and 2d is stretched between a secondary transfer counter roller 10 and a tension roller 11. The secondary transfer counter roller 10 is arranged such that it can be brought into contact with the secondary transfer roller 12 at a secondary transfer point 34, with the intermediate transfer belt 8 interposed between the secondary transfer counter roller 10 and the secondary transfer roller 12. The intermediate transfer belt 8 is a dielectric resin film, such as a polycarbonate film, a polyethylene terephthalate resin film, or a polyvinylidene fluoride resin film.

The intermediate transfer belt 8 is arranged such that a primary transfer surface 8a, which is a flat undersurface thereof facing the photosensitive drums 2a, 2b, 2c, and 2d, is inclined downward toward the secondary transfer roller 12.

In other words, the intermediate transfer belt 8 is arranged such that the primary transfer surface 8a, which is movable over the photosensitive drums 2a, 2b, 2c, and 2d, is inclined downward toward the secondary transfer point 34.

Specifically, the primary transfer surface 8a is inclined at an angle of about 15°. The intermediate transfer belt 8 is supported by two rollers, the secondary transfer counter roller 10 and the tension roller 11. The secondary transfer counter roller 10 is disposed adjacent to the secondary transfer point 34 and applies a driving force to the intermediate transfer belt 8. The tension roller 11 is disposed opposite the secondary transfer counter roller 10 with the primary transfer points 32a, 32b, 32c, and 32d interposed therebetween and applies tension to the intermediate transfer belt 8.

A belt cleaner (not shown) for removing and recovering residual toner remaining untransferred on the surface of the intermediate transfer belt 8 is disposed outside the endless intermediate transfer belt 8 and near the tension roller 11.

A fixing device 16 including a fixing roller 16a and a pressure roller 16b is disposed downstream of the secondary transfer point 34 in the sheet conveying direction. The fixing device 16 is arranged such that a sheet is conveyed vertically between the fixing roller 16a and the pressure roller 16b.

The laser exposure unit 7 includes a laser emitting device, a polygonal lens, and a reflecting mirror. The laser emitting device emits light according to time-series electric digital pixel signals of given image information. The laser exposure unit 7 exposes the photosensitive drums 2a, 2b, 2c, and 2d to light, thereby forming electrostatic latent images of respective colors corresponding to the image information on the respective surfaces of the photosensitive drums 2a, 2b, 2c, and 2d charged by the primary chargers 3a, 3b, 3c, and 3d.

Next, an image forming operation of the printer 102 will be described.

For example, in response to a print instruction from the host computer 101, the printer 102 performs the following control. The photosensitive drums 2a, 2b, 2c, and 2d rotated and driven at a predetermined processing speed are uniformly negatively charged by the primary chargers 3a, 3b, 3c, and 3d, respectively.

Then, color-separated image signals externally input are output from the laser emitting device of the laser exposure unit 7 in the form of laser light. The laser light passes through the polygonal lens and the reflecting mirror to form electrostatic latent images of the respective colors on the photosensitive drums 2a, 2b, 2c, and 2d.

First, in the image forming unit 1Y, the developing device 4a to which a developing bias having the same polarity as a charging polarity (negative polarity) of the photosensitive drum 2a is applied causes yellow toner to adhere to the electrostatic latent image formed on the photosensitive drum 2a, thereby developing the electrostatic latent image into a visible yellow toner image.

At the primary transfer point 32a between the photosensitive drum 2a and the transfer roller 5a, the yellow toner image is primary-transferred onto the driven intermediate transfer belt 8 by the transfer roller 5a to which a primary transfer bias (with a polarity (positive polarity) opposite that of the toner) is applied.

The intermediate transfer belt 8 to which the yellow toner image has been transferred is moved toward the image forming unit 1M. In the image forming unit 1M, in a manner similar to that described above, a magenta toner image formed on the photosensitive drum 2b is transferred at the primary transfer point 32b onto the yellow toner image on the intermediate transfer belt 8.

The residual toners remaining untransferred on the photosensitive drums 2a, 2b, 2c, and 2d are scratched off, for example, by the cleaning blades of the respective drum cleaners 6a, 6b, 6c, and 6d and recovered.

Likewise, cyan and black toner images formed on the respective photosensitive drums 2c and 2d of the image forming units 1C and 1Bk are sequentially superimposed, at the respective primary transfer points 32c and 32d, on the yellow and magenta toner images having been transferred onto the intermediate transfer belt 8. Thus, a full-color toner image is formed on the intermediate transfer belt 8.

Then, simultaneously with the time at which the leading end of the full-color toner image on the intermediate transfer belt 8 reaches the secondary transfer point 34, a sheet for recording is conveyed to the secondary transfer point 34 by registration rollers 19. The sheet is picked up from a sheet feed cassette 17 or a manual feed tray 20 and fed along a conveying path 18.

At the secondary transfer point 34, the full-color toner image is secondary-transferred to the sheet by the secondary transfer roller 12 to which a secondary transfer bias (with a polarity (positive polarity) opposite that of the toner) is applied.

The sheet on which the full-color toner image has been formed is conveyed to the fixing device 16. At a fixing nip 31 between the fixing roller 16a and the pressure roller 16b, the full-color toner image is subjected to heat and pressure and thermally fixed to the surface of the sheet. Then, the sheet enters the post-processing unit 401 (described in detail below) by means of ejection rollers 21 and is ejected onto a sheet output tray 22 on the main body of the printer 102. Thus, a series of image forming operations are completed. The ejection rollers 21 are driven by the motor 807.

Residual toners remaining on the intermediate transfer belt 8 after secondary transfer are removed and recovered by the belt cleaner.

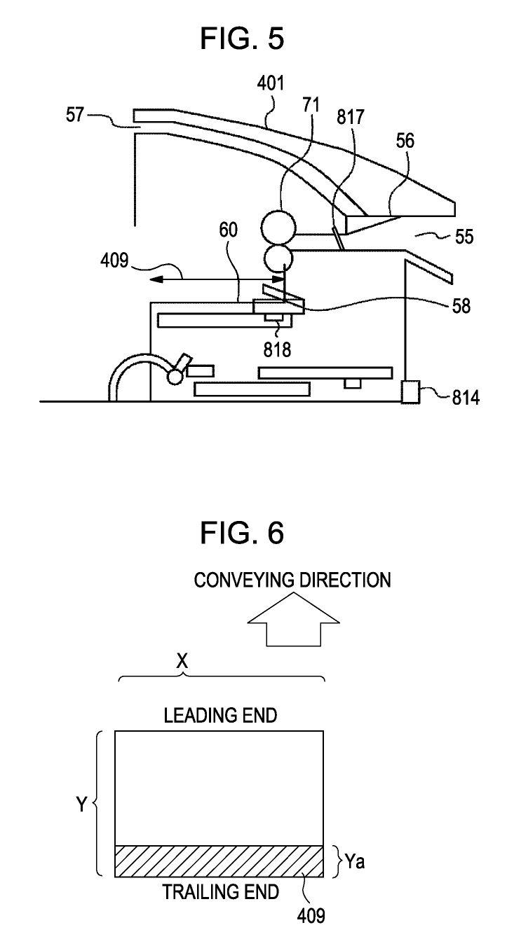

Next, with reference to FIG. 5, a configuration of the post-processing unit 401 shown in FIG. 4 will be described in detail.

The post-processing unit 401 which performs post-processing after image formation is provided with a sheet entrance 55, which allows a sheet to be conveyed into the post-processing unit 401 by the ejection rollers 21. For allowing the sheet to be conveyed from the main body of the printer 102 to the post-processing unit 401, the main body of the printer 102 and the post-processing unit 401 are brought into synchronization by communication via a printer engine I/F 814. Additionally, the sheet sensor 817 detects the entrance of the sheet through the sheet entrance 55. The sheet conveyed through the sheet entrance 55 is ejected onto a bundle tray 60 by normal rotation of conveying rollers 71. The conveying rollers 71 are driven by the motor 805 (see FIG. 3) of the printer engine 303. A mechanism (not shown), such as a clutch, allows normal and reverse rotations of the conveying rollers 71.

Sheets ejected and temporarily loaded on the bundle tray 60 are moved horizontally relative to the ejecting direction by a sorting member (not shown). This processing is referred to as sorting.

Every time a predetermined number of sheets are conveyed from the main body of the printer 102, the sheets are moved in the sorting direction and aligned. After a predetermined number of sheets are loaded on the bundle tray 60, the sheets are stapled by a stapler (not shown) if necessary. Then, the loaded sheets are ejected by a bundle output slider 58 onto the sheet output tray 22. The temperature sensor 809 is provided near the sheet output tray 22 and detects the temperature near the sheet output tray 22.

The bundle tray 60 is provided with the sheet sensor 818, which detects whether there is a sheet on the bundle tray 60. The sheet sensor 818 then informs the printer engine 303 of the result of the detection via the printer engine I/F 814.

The foregoing description is about single-sided image formation performed by the printer 102 of the present embodiment. Next, duplex image formation will be described.

As in the case of the single-sided image formation described above, a full-color toner image is thermally fixed to the surface of each sheet by the fixing device 16. After the thermal fixing, when most sheets are ejected onto the sheet output tray 22 at the top of the main body by the ejection rollers 21, the rotation of the ejection rollers 21 is stopped.

The rotation is stopped such that the trailing end of a sheet reaches a reversing position 42 (see FIG. 4). By switching a flapper 56 of the post-processing unit 401 in advance, the sheet in the post-processing unit 401 is guided to a conveying path 57.

To convey the sheet stopped by stopping the rotation of the ejection rollers 21 to a duplex path provided with duplex rollers 40 and 41, the ejection rollers 21 are rotated in a reverse direction opposite that of normal rotation. By the reverse rotation of the ejection rollers 21, the trailing end of the sheet located at the reversing position 42 becomes the leading end thereof and reaches the duplex rollers 40.

Then, the sheet is conveyed by the duplex rollers 40 to the duplex rollers 41. While sheets are sequentially conveyed by the duplex rollers 40 and 41 toward the registration rollers 19, a start signal for starting image formation is generated.

As in the case of the single-sided image formation described above, a sheet is moved by the registration rollers 19 to the secondary transfer point 34 between the secondary transfer counter roller 10 and the secondary transfer roller 12, in synchronization with movement of the leading end of the full-color toner image on the intermediate transfer belt 8 to the secondary transfer point 34.

After the leading end of the toner image coincides with the leading end of the sheet and the toner image is transferred to the sheet at the secondary transfer point 34, the image on the sheet is fixed by the fixing device 16 as in the case of the single-sided image formation. Then, the sheet is conveyed by the ejection rollers 21 again to the post-processing unit 401 and ejected onto the bundle tray 60. The sheet is eventually ejected onto the sheet output tray 22. Thus, a series of image forming operations are completed.

As described above, sheets are held on the bundle tray 60 until the post-processing unit 401 performs post-processing. Sheets are held on the bundle tray 60 not only in the case where post-processing, such as stapling, is required. Sheets loaded on the bundle tray 60 may be ejected together by being driven by the bundle output slider 58.

To realize a compact image forming apparatus, the post-processing unit 401 does not have a fan near the bundle tray 60. As a result, heat tends to accumulate near the bundle tray 60. Therefore, while sheets on which a large amount of toner is deposited are held on the bundle tray 60, the sheets tend to stick together due to heat provided by the fixing device 16 for a fixing operation. Even if sheets are attempted to be aligned for stapling, the sheets sticking together cannot be aligned properly.

In the present embodiment, to prevent sheets from sticking together due to toner fusion, the printer 102 rotates the conveying rollers 71 in normal and reverse directions, with a sheet held between the conveying rollers 71. Thus, since the sheet is reciprocated by the printer 102, toner transferred to the sheet can be efficiently dried with an air flow. This can reduce the possibility of occurrence of toner fusion in each sheet.

However, if every sheet on which a target page is to be printed is reciprocated, it takes time to complete the printing, and thus the productivity is degraded. Therefore, the present embodiment describes the case where the CPU 703 determines the amount of toner deposited on a sheet and sheet reciprocation is performed when the amount of toner deposition is large.

FIG. 6 illustrates a sheet as viewed from above the post-processing unit 401, the sheet being conveyed upward in the drawing. As also illustrated in FIG. 5, a region 409 is an area on which sheets are stacked on the bundle tray 60 of the post-processing unit 401. The region 409 is held by the post-processing unit 401 during post-processing performed by the post-processing unit 401. Hereinafter, this region 409 is referred to as fusion region 409. Incidentally, FIG. 5 shows the region 409 extending along the full length of the bundle tray 60. As can be observed in FIG. 4 which shows sheets in the cassette 17, the sheets are, in general, much longer (dimension Y in FIG. 6) than the bundle tray 60, so that most of a sheet discharged onto the bundle tray 60 for stacking is beyond the post-processing unit 401, i.e. extending over the sheet output tray 22, and only the region 409 at the trailing end of the discharged sheet is on the bundle tray 60.

Since the fusion region 409 is held by the post-processing unit 401, heat provided by the fixing device 16 is not easily released. In other words, the fusion region 409 is an area where toner fusion tends to occur in each sheet after toner is fixed to the sheet.

Here, X denotes the length of the sheet in a main scanning direction, Y denotes the length of the sheet in a sub-scanning direction, and Ya denotes the length of the fusion region 409 in the sub-scanning direction.

These values X, Y, and Ya are stored in the ROM 704 in advance. The CPU 703 can obtain these values as necessary. The values X and Y, which are determined for each sheet size, are associated with sheet size information and stored in the ROM 704. The value Ya, which is determined by the length of the bundle tray 60 of the post-processing unit 401, is stored in the ROM 704 depending on the type of the post-processing unit 401.

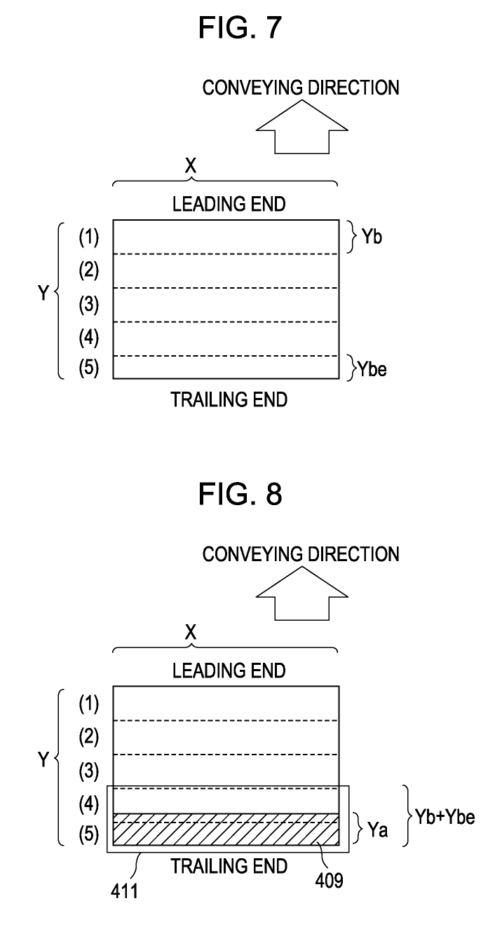

FIG. 7 illustrates a sheet as viewed from above the post-processing unit 401, the sheet being conveyed upward in the drawing. FIG. 7 illustrates boundaries between bands on the sheet. Here, (1) to (5) are band numbers counted from the leading end of the sheet.

For memory saving purposes, the CPU 703 divides print data formed per page into a plurality of bands, and processes the print data band-by-band in the memory.

For generating intermediate data from the print data, the CPU 703 starts generating bands, each having a predetermined amount of data, at the beginning of the print data. As a result, the amount of data of the band at the end of the page may be smaller than the predetermined amount. For example, in the first to fourth bands in FIG. 7, the amount of data of each band is a predetermined value and the length of each band in the sub-scanning direction is Yb. However, the amount of data of the fifth band, which is the last band, is smaller than the predetermined value and the length of the fifth band in the sub-scanning direction is Ybe, which is smaller than Yb.

FIG. 8 illustrates a sheet as viewed from above the post-processing unit, the sheet being conveyed upward in the drawing. FIG. 8 is obtained by superimposing the fusion region 409 illustrated in FIG. 6 on the boundaries of bands illustrated in FIG. 7. In FIG. 8, as in the case of FIG. 7, (1) to (5) are band numbers counted from the leading end of the sheet.

To determine the possibility of occurrence of toner fusion, the CPU 703 uses information about video counts counted in the band-by-band processing. A video count is a value expressed by gradation of one byte per dot. The greater the video count, the greater the amount of toner consumption. The CPU 703 uses a video count for each band to calculate the amount of toner deposited in the fusion region 409.

For example, for the sheet illustrated in FIG. 8, the CPU 703 obtains the amount of data deposited in a region 411 composed of a plurality of bands including the fusion region 409, by using video counts for these bands. Hereinafter, this region 411 is referred to as evaluation region 411. In the example of FIG. 8, a region composed of the fourth and fifth bands from the top is the evaluation region 411, whose length in the sub-scanning direction is (Yb+Ybe).

Here, only part of the sheet, instead of the entire sheet, is used as an evaluation region to determine the possibility of occurrence of toner fusion. Since a region to be subjected to calculation for determining the amount of toner deposited is limited to a small region, the time for calculating the amount of toner deposited can be reduced. For more accurate determination, the entire sheet may be used as an evaluation region to determine the possibility of occurrence of toner fusion.

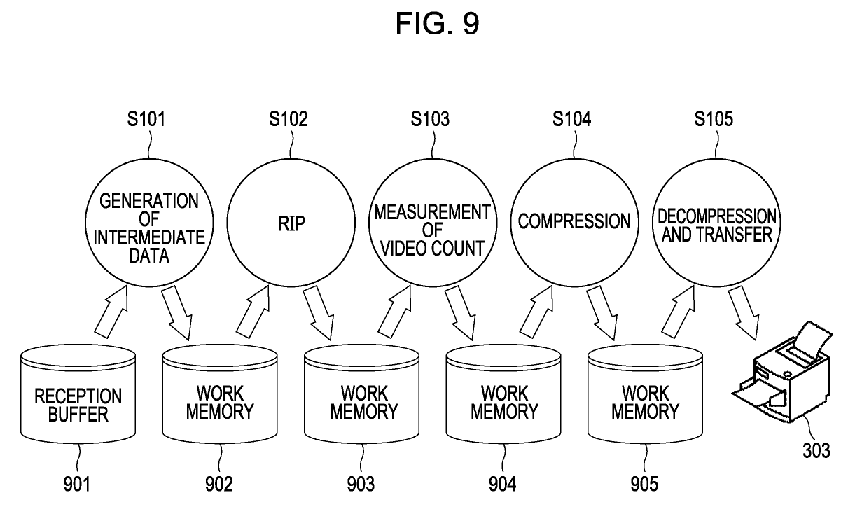

FIG. 9 is a schematic view illustrating a flow of data processing performed by the CPU 703.

A reception buffer 901 of FIG. 9 is included in the RAM 705 or HDD 711 of the printer controller 302 (see FIG. 2).

First, upon receipt of a print instruction and print data from the host computer 101, the CPU 703 stores the received print data, for example, in the reception buffer 901 in the RAM 705. The CPU 703 reads the print data from the reception buffer 901 to generate intermediate data in step S101. Then, the CPU 703 stores the generated intermediate data in a work memory 902 in the RAM 705.

In step S102, the CPU 703 reads the intermediate data stored in the work memory 902 and performs raster image processing (RIP) to expand the read intermediate data into a bitmap image. Then, the CPU 703 stores the resulting bitmap image in a work memory 903 in the RAM 705.

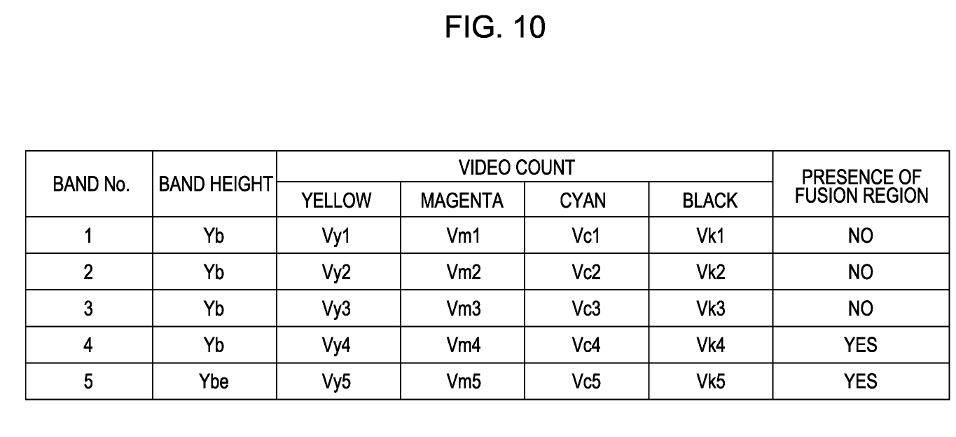

In step S103, on the basis of the bitmap image in the work memory 903, the CPU 703 measures the video count for each band in each page. Then, the CPU 703 stores the obtained video counts together with the height of each band in an information table shown in FIG. 10.

The information table of FIG. 10 is stored in the RAM 705 with respect to each page of the bitmap data. For each band, the CPU 703 stores information about the height of the band, information about the video count for each color component, and information as to whether there is a fusion region.

In FIG. 10, “BAND No.” column contains identifiers assigned sequentially from the band at the leading end of the sheet illustrated in FIG. 7 and FIG. 8. Band No. 1 to band No. 5 correspond to the respective band numbers (1) to (5) in FIG. 7 and FIG. 8.

“BAND HEIGHT” column contains the length of each band in the sub-scanning direction, the band being processed by the CPU 703. In the case of the sheet illustrated in FIG. 8, the band height of each of band No. 1 to band No. 4 is Yb, while the band height of band No. 5 is Ybe.

“VIDEO COUNT” column contains information about video counts which are values, each being expressed by gradation of one byte per dot and processed for each band by the CPU 703.

“PRESENCE OF FUSION REGION” column contains information indicating whether each band includes the fusion region 409. The value “YES” indicates that the band includes the fusion region 409, and the value “NO” indicates that the band does not include the fusion region 409. In the case of the sheet illustrated in FIG. 8, band No. 4 and band No. 5 includes the fusion region 409.

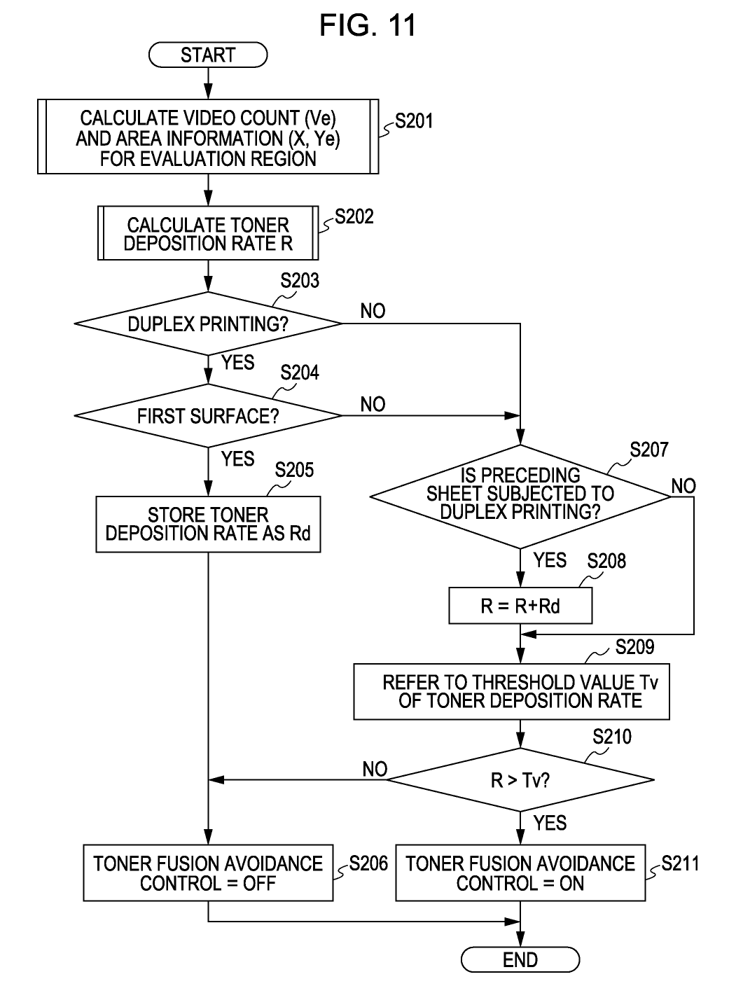

After the height and video counts for each band are stored in the information table of FIG. 10 in step S103, the CPU 703 performs control illustrated in FIG. 11 to FIG. 13 on data of each page. Then, the resulting information is associated with the data of each page and stored by the CPU 703 in a work memory 904 in the RAM 705.

In step S104, the CPU 703 compresses the bitmap image stored in the work memory 904 and stores the compressed bitmap image in a work memory 905 in the RAM 705.

In step S105, the CPU 703 transmits the compressed bitmap image to the printer engine 303 while decompressing it. At the same time, the CPU 703 informs the printer engine 303 of bitmap data to be printed and information for performing toner fusion avoidance control (which is a control operation for avoiding toner fusion).

The process illustrated in the flowchart of FIG. 11 is performed by the CPU 703 in step S103 of FIG. 9. Specifically, the process of FIG. 11 is a determining process in which, with respect to each page, a determination is made as to whether to perform toner fusion avoidance control on a sheet on which the page is to be printed. The process of FIG. 11 is performed when the CPU 703 executes a program stored in the ROM 704.

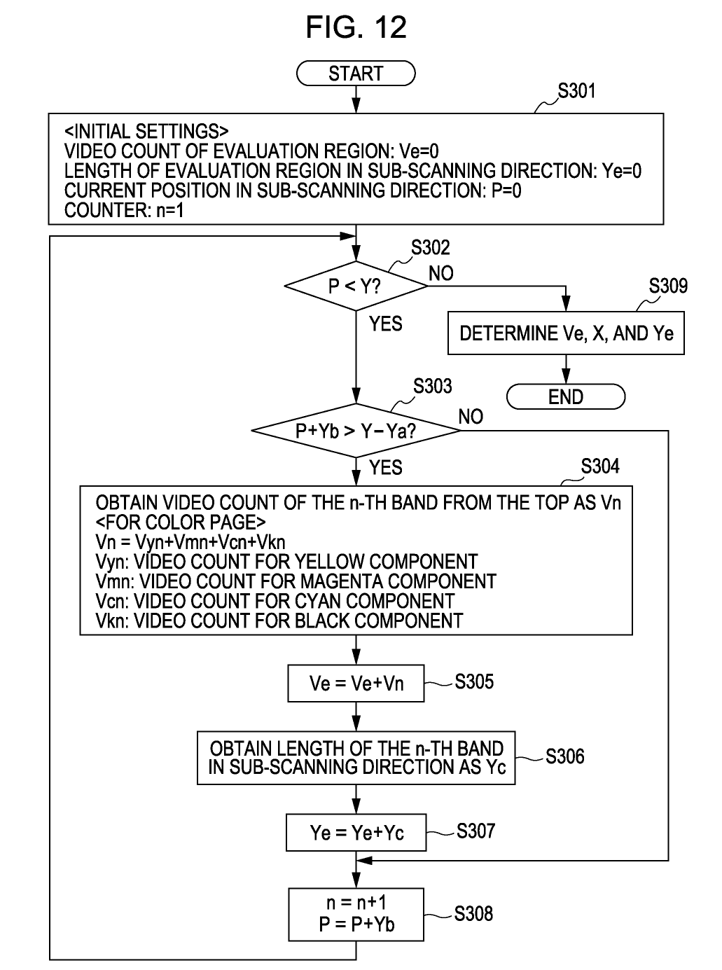

In step S201 of FIG. 11, in a manner illustrated in FIG. 12, the CPU 703 calculates a video count (Ve) and area information (X, Ye) for the evaluation region 411 in a page on which the process of FIG. 11 is to be performed (hereinafter, this page is referred to as determination target page).

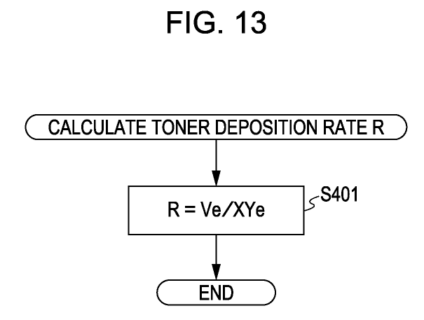

In step S202, from the video count and area information calculated in step S201, the CPU 703 calculates a toner deposition rate in the evaluation region 411 in the determination target page, in a manner illustrated in FIG. 13.

In step S203, the CPU 703 determines whether the determination target page is specified to be duplex printed. This determination is made because the amount of toner to be deposited is different among successive sheets depending on whether duplex printing is specified, the amount being used to determine whether to perform toner fusion avoidance control.

If it is determined in step S203 that the determination target page is specified to be duplex printed, the process proceeds to step S204. In step S204, the CPU 703 determines whether the determination target page is to be printed on the first surface of a sheet in duplex printing.

If it is determined in step S204 that the determination target page is to be printed on the first surface of the sheet, the process proceeds to step S205.

In step S205, the CPU 703 stores in the RAM 705 the toner deposition rate calculated in step S202 as “Rd”. Then, the process proceeds to step S206.

In step S206, the CPU 703 associates a “toner fusion avoidance control=OFF” flag with data of the determination target page and stores them in the RAM 705.

If the CPU 703 determines in step S203 that the determination target page is not specified to be duplex printed but is specified to be single-sided printed, the process proceeds to step S207. If the CPU 703 determines in step S204 that the determination target page is not to be printed on the first surface but on the second surface of the sheet, the process proceeds to step S207.

In step S207, the CPU 703 determines whether the preceding sheet, which is to be output one sheet before the sheet on which the determination target page is to be printed, is specified to be subjected to duplex printing. If it is determined in step S207 that the preceding sheet is specified to be subjected to duplex printing, the process proceeds to step S208. In step S208, the CPU 703 adds the toner deposition rate Rd in the first surface of the preceding sheet to “R” calculated in step S202 as a toner deposition rate of the determination target page. Then, the process proceeds to step S209. The reason why the toner deposition rate Rd in the first surface of the preceding sheet is added to “R” in step S208 is that when the preceding sheet is subjected to duplex printing, a surface on which the determination target page is to be printed faces the first surface of the preceding sheet. If it is determined in step S207 that the preceding sheet is not subjected to duplex printing, the process proceeds to step S209.

In step S209, the CPU 703 refers to a threshold value Tv of the toner deposition rate, the threshold value Tv being stored in the RAM 705 in advance. In step S210, the CPU 703 determines whether the toner deposition rate R is greater than the threshold value Tv. If the CPU 703 determines in step S210 that the toner deposition rate R is greater than the threshold value Tv (R>Tv), the process proceeds to step S211.

In step S211, the CPU 703 determines that it is necessary to reciprocate the sheet on which the determination target page is to be printed. Then, the CPU 703 associates a “toner fusion avoidance control=ON” flag with the data of the determination target page and stores them in the RAM 705.

If the CPU 703 determines in step S210 that the toner deposition rate R is not greater than the threshold value Tv, the process proceeds to step S206. In step S206, the CPU 703 determines that it is not necessary to reciprocate the sheet on which the determination target page is to be printed. Then, the CPU 703 associates the “toner fusion avoidance control=OFF” flag with the data of the determination target page and stores them in the RAM 705.

The threshold value Tv may be set by the user, for example, from the operation unit 301 or the host computer 101.

FIG. 12 is a flowchart illustrating the calculation performed in step S201 of FIG. 11 by the CPU 703 to determine the video count (Ve) and area information (X, Ye) for the evaluation region 411. The process illustrated in FIG. 12 is performed when the CPU 703 executes a program stored in the ROM 704.

The CPU 703 performs the process illustrated in the flowchart of FIG. 12 with respect to each band of the determination target page.

In step S301, the CPU 703 resets various variables to initial settings. Specifically, the variables, that is, the video count Ve of the evaluation region 411 is set to zero (Ve=0), the length Ye of the evaluation region 411 in the sub-scanning direction is set to zero (Ye=0), a current position P in the sub-scanning direction is set to zero (P=0), and a counter n is set to one (n=1). The current position P in the sub-scanning direction is initially set to the leading end of the sheet. Then, the current position P approaches the trailing end of the sheet every time a length in the sub-scanning direction is added thereto.

In step S302, the CPU 703 determines whether the current position P in the sub-scanning direction is smaller than the length Y of the determination target page (P<Y). If the CPU 703 determines that P<Y is satisfied, the process proceeds to step S303. If the CPU 703 determines that P<Y is not satisfied, the process proceeds to step S309.

In step S303, the CPU 703 determines whether the evaluation region 411 is included in a target band to be processed. Specifically, the CPU 703 determines whether a value obtained by adding the band length Yb to the current position P in the sub-scanning direction is greater than a value obtained by subtracting the length Ya of the fusion region 409 in the sub-scanning direction from the length Y of the determination target page in the sub-scanning direction (P+Yb>Y−Ya). If it is determined in step S303 that P+Yb>Y−Ya is satisfied, the CPU 703 determines that the evaluation region 411 is included in the target band. Then, the process proceeds to step S304. If it is determined in step S303 that P+Yb>Y−Ya is not satisfied, the process proceeds to step S308.

In step S304, on the basis of the information table of FIG. 10, the CPU 703 obtains the video count of the target band as “Vn”. If the determination target page is a color page, the video count is calculated by Vn=Vyn+Vmn+Vcn+Vkn, while if the determination target page is monochrome, the video count is calculated by Vn=Vkn. Here, Vyn, Vmn, Vcn, and Vkn denote video counts of yellow, magenta, cyan, and black components.

In step S305, the CPU 703 adds the video count Vn calculated in step S304 to the video count Ve (Ve=Ve+Vn).

In step S306, the CPU 703 obtains the length of the target band in the sub-scanning direction as “Yc”. Then, in step S307, the CPU 703 adds the length Yc obtained in step S306 to the length Ye of the evaluation region 411 (Ye=Ye+Yc).

In step S308, the CPU 703 increments the counter n (n=n+1) and adds the band length Yb to the current position P in the sub-scanning direction (P=P+Yb).

Then, the process of step S302 to step 308 is repeated. If the CPU 703 determines in step S302 that the current position P is greater than or equal to the length Y of the determination target page (P≧Y) in the sub-scanning direction, the process proceeds to step S309. In step S309, the CPU 703 stores, in the RAM 705, the video count (Ve) of the evaluation region 411 and the area information (X, Ye) for the evaluation region 411 as a result of calculation for the determination target page.

FIG. 13 is a flowchart illustrating the calculation performed in step S202 of FIG. 11 by the CPU 703 to determine the toner deposition rate in the evaluation region 411. The process illustrated in FIG. 13 is performed when the CPU 703 executes a program stored in the ROM 704.

In step S401, on the basis of the value calculated in step S202 of FIG. 11, the CPU 703 calculates the toner deposition rate R as a value obtained by dividing the video count Ve of the evaluation region 411 by an area XYe of the evaluation region 411.

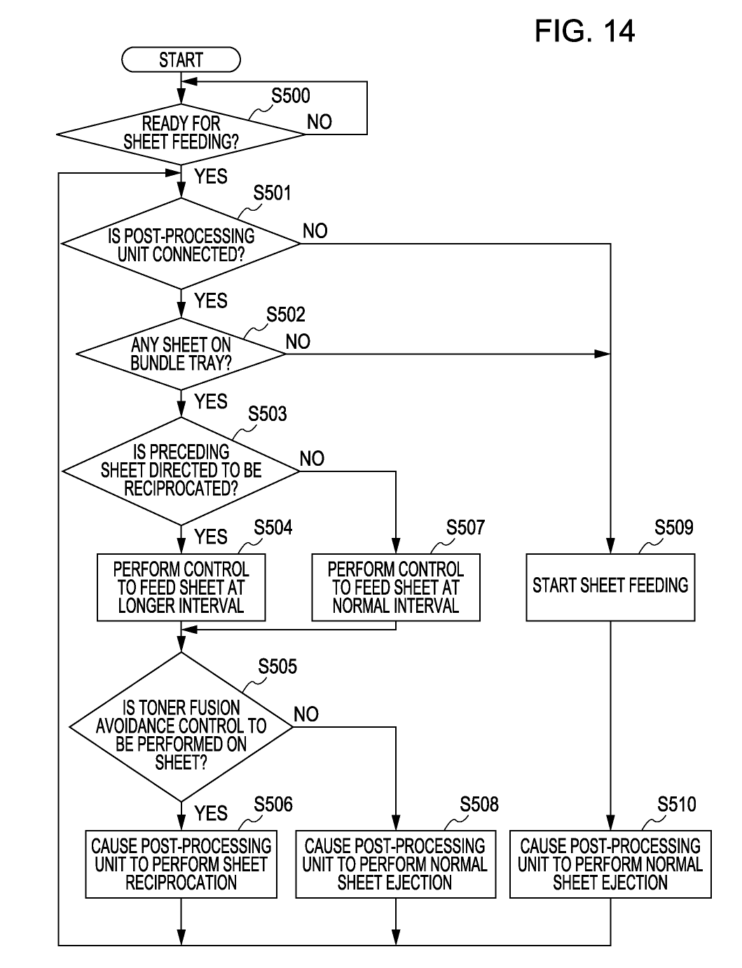

FIG. 14 is a flowchart illustrating a procedure of toner fusion avoidance control performed by the MPU 802 of the printer engine 303. From the CPU 703 of the printer controller 302, the MPU 802 receives bitmap data to be printed; a flag related to toner fusion avoidance control and associated with a page; and information indicating, with respect to each page, whether the page is to be duplex-printed. Before starting feeding a sheet, the MPU 802 performs the process of FIG. 14 on the sheet to be fed. The process of FIG. 14 is performed when the MPU 802 executes a program stored in the ROM 803.

In step S500 of FIG. 14, upon receipt of a print start instruction from the CPU 703, the MPU 802 determines whether it is possible to start feeding a sheet. If the MPU 802 determines that it is possible, the process proceeds to step S501.

In step S501, the MPU 802 determines whether the post-processing unit 401 is connected to the printer 102 according to, for example, a signal from a sensor (not shown) for detecting the connection of the post-processing unit 401. If the post-processing unit 401 is not connected to the printer 102, the process proceeds to step S509, where the MPU 802 starts feeding a sheet. Then, in step S510, the MPU 802 performs control such that the post-processing unit 401 performs a normal sheet ejecting operation. If it is determined in step S501 that the post-processing unit 401 is connected to the printer 102, the process proceeds to step S502.

In step S502, according to an output from the sheet sensor 818, the MPU 802 determines whether there is any sheet on the bundle tray 60. If it is determined in step S502 that there is any sheet on the bundle tray 60, the process proceeds to step S503. If it is determined in step S502 that there is no sheet on the bundle tray 60, the process proceeds to step S509, where the MPU 802 starts feeding a sheet. Then, in step S510, the MPU 802 performs control such that the post-processing unit 401 performs a normal sheet ejecting operation.

In step S503, the MPU 802 determines whether the immediately preceding sheet, which was fed one sheet before, is specified to be reciprocated. If it is determined in step S503 that the preceding sheet is not specified to be reciprocated, the process proceeds to step S507. In step S507, the MPU 802 feeds a sheet to be subjected to printing at a normal distance from the preceding sheet. Then, the process proceeds to step S505.

If it is determined in step S503 that the preceding sheet is specified to be reciprocated, the process proceeds to step S504. In step S504, in consideration of the time taken to reciprocate the preceding sheet, the MPU 802 starts feeding a sheet at a greater distance from the preceding sheet. Additionally, if the preceding page is specified to be duplex-printed and after the preceding sheet is subjected to duplex printing, the MPU 802 does not start feeding the succeeding sheet until reciprocation of the preceding sheet is performed. Then, in consideration of the time taken to reciprocate the preceding sheet, the MPU 802 starts feeding the succeeding sheet. Therefore, the sheet subjected to duplex printing can be prevented from colliding with the succeeding sheet on the sheet conveying path. At the same time, it is possible to prevent the situation where the succeeding sheet is fed before completion of the reciprocation of the sheet subjected to duplex printing and then, the succeeding sheet is forced into a standby state in the middle of transfer or fixing operation performed thereon. Then, the process proceeds to step S505.

In step S505, on the basis of the flag associated with each page and indicating whether to perform toner fusion avoidance control, the MPU 802 determines whether the sheet on which the page is to be printed is one on which toner fusion avoidance control is to be performed. If the page is specified to be single-sided printed on the sheet, the MPU 802 determines, on the basis of the flag associated with this page, whether to perform toner fusion avoidance control on the sheet. If it is determined in step S505 that the sheet to be fed is one on which toner fusion avoidance control is to be performed, the process proceeds to step S506. In step S506, the MPU 802 performs control such that the sheet is reciprocated a predetermined number of times while being held by the conveying rollers 71 (see FIG. 5) and without being flipped over. With the sheet being held, the MPU 802 rotates the conveying rollers 71 only once by a predetermined amount and conveys the sheet in the direction opposite the ejecting direction. Then, the MPU 802 may either eject the sheet in the ejecting direction or repeat the normal and reverse rotations of the sheet multiple times.

If it is determined in step S505 that the sheet to be fed is not one on which toner fusion avoidance control is to be performed, the process proceeds to step S508. In step S508, the MPU 802 directs the post-processing unit 401 to eject the sheet onto the bundle tray 60 by a normal sheet ejecting operation.

With the control process described above, even if the post-processing unit 401 has no cooling fan, toner on the sheet can be efficiently dried by a sheet reciprocating operation. Thus, it is possible to effectively prevent sheets from sticking together due to toner fusion caused by heat.

Additionally, a reduction in productivity associated with the sheet reciprocating operation occurs only in sheets which are likely to stick together due to toner fusion. In other words, sheets which are unlikely to stick together can be output with productivity maintained.

In the example described above, it is determined whether the sheet is one on which toner fusion avoidance control is to be performed, and if a predetermined condition is satisfied (e.g., if the amount of toner deposited on the sheet is greater than a predetermined value), toner fusion avoidance control is performed on the sheet. However, the present embodiment is not limited to this. Toner fusion avoidance control may be performed on every sheet without exception. This eliminates the need of performing the foregoing determination process and makes it possible to reliably prevent sheets from sticking together due to toner fusion.

The present embodiment describes the case where the processes illustrated by the flowcharts of FIG. 11 and FIG. 12 are performed by the CPU 703, while the process illustrated by the flowchart of FIG. 14 is performed by the MPU 802. However, the present embodiment is not limited to this. The process illustrated by the flowchart of FIG. 14 may be performed by the CPU 703, while some steps in FIG. 11 and FIG. 12 may be performed by the MPU 802. For example, after the CPU 703 of the printer controller 302 performs step S201 of FIG. 11, the CPU 703 may inform the printer engine 303 of the calculated video count Ve and area information (X, Ye). Then, on the basis of these values, MPU 802 of the printer engine 303 may perform step S202 and the following steps.

### Second Exemplary Embodiment

A second embodiment describes a case where, in the process of toner fusion avoidance control, a determination of toner fusion is made on the basis of a temperature near the post-processing unit 401.

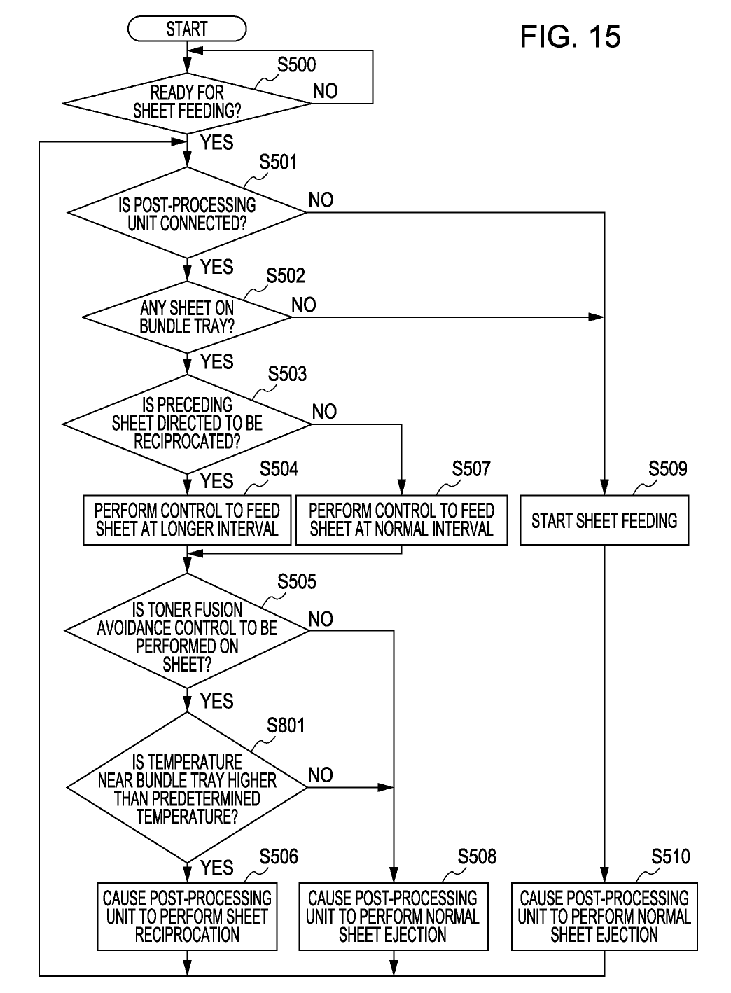

FIG. 15 is a flowchart illustrating a process performed by the host computer 101 to make a determination of toner fusion. The process illustrated in FIG. 15 is performed when the CPU 703 executes a program stored in the ROM 704. Steps that are identical to those described in the first embodiment will not be described here.

In step S505 of FIG. 15, on the basis of a flag (see FIG. 11) indicating whether toner fusion avoidance control is to be performed, it is determined whether a sheet to be fed is one on which toner fusion avoidance control is to be performed. If it is determined in step S505 that the sheet is one on which toner fusion avoidance control is to be performed, the process proceeds to step S801.

In step S801, the MPU 802 detects a temperature near the bundle tray 60 with the temperature sensor 819. If the MPU 802 determines that the temperature near the bundle tray 60 is higher than a predetermined temperature Tp, the process proceeds to step S506. In S506, the MPU 802 causes the post-processing unit 401 to reciprocate the sheet using the conveying rollers 71 (see FIG. 5).

If it is determined in step S801 that the temperature near the bundle tray 60 is not higher than the predetermined temperature Tp, the process proceeds to step S508. In S508, the MPU 802 causes the post-processing unit 401 to eject the sheet onto the bundle tray 60 by a normal sheet ejecting operation.

With the control process described above, if the temperature near the ejection unit (e.g., bundle tray 60) is low during sheet ejection, and thus toner fusion due to heat is less likely to occur, a reduction in productivity can be prevented by performing normal sheet ejection.

In the present embodiment describes above, a determination as to whether sheet reciprocation is to be performed is made on the basis of both the amount of toner deposited and the temperature near the ejection unit. Alternatively, the determination as to whether to perform sheet reciprocation may be made only on the basis of the temperature.

### Third Exemplary Embodiment

In the embodiments described above, as shown in FIG. 13, a toner deposition rate is calculated by dividing the video count Ve of the evaluation region 411 by the area XYe of the evaluation region 411. However, a value obtained by dividing the video count Ve of the evaluation region 411 by the area XYa of the fusion region 409 may be output as a toner deposition rate.

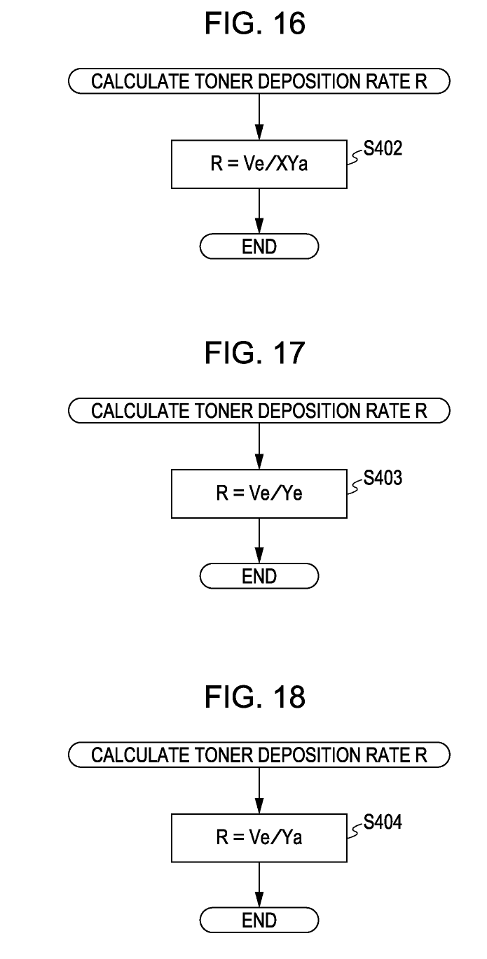

FIG. 16 is a flowchart illustrating a process of calculating a toner deposition rate in the evaluation region 411. The process of FIG. 16 is performed when the CPU 703 executes a program stored in the ROM 704.

In step S402 of FIG. 16, a value obtained by dividing the video count Ve of the evaluation region 411 by the area XYa of the fusion region 409 is output as a toner deposition rate R.

### Fourth Exemplary Embodiment

In embodiments described above, as shown in FIG. 13, a toner deposition rate is calculated as a video count value per pixel which is obtained by dividing the video count Ve of the evaluation region 411 by the area XYe of the evaluation region 411. However, the toner deposition rate may be output as a video count value per line which is obtained by dividing the video count Ve of the evaluation region 411 by the length Ye of the evaluation region 411 in the conveying direction.

FIG. 17 is a flowchart illustrating a process of calculating a toner deposition rate in the evaluation region 411. The process of FIG. 17 is performed when the CPU 703 executes a program stored in the ROM 704.

In step S403 of FIG. 17, a value obtained by dividing the video count Ve of the evaluation region 411 by the length Ye of the evaluation region 411 in the conveying direction is calculated as a toner deposition rate R.

### Fifth Exemplary Embodiment

In embodiments described above, as shown in FIG. 13, a toner deposition rate is calculated as a video count value per pixel which is obtained by dividing the video count Ve of the evaluation region 411 by the area XYe of the evaluation region 411. However, the toner deposition rate may be output as a video count value per line which is obtained by dividing the video count Ve of the evaluation region 411 by the length Ya of the fusion region 409 in the conveying direction.

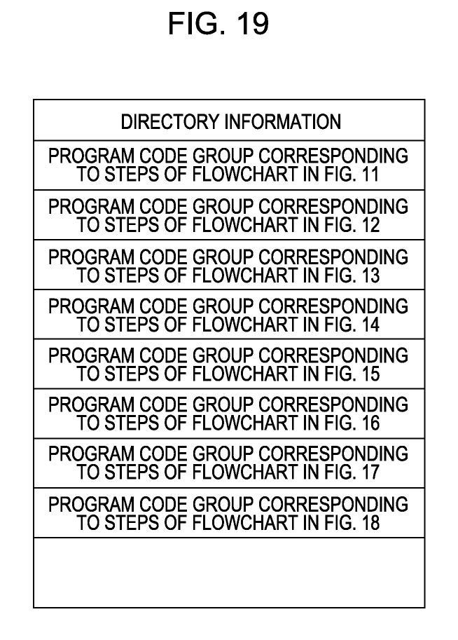

FIG. 18 is a flowchart illustrating a process of calculation performed by the printer engine 303 to determine a toner deposition rate in the evaluation region 411.

In step S404 of FIG. 18, a value obtained by dividing the video count Ve of the evaluation region 411 by the length Ya of the evaluation region 411 in the conveying direction is calculated as a toner deposition rate R.

### Sixth Exemplary Embodiment

In embodiments described above, it is determined in step S501 of FIG. 14 or FIG. 15 whether the post-processing unit 401 is connected to the printer 102. Then, on the basis of this determination, it is determined whether sheet reciprocation is to be performed. However, the present invention is not limited to this. After it is determined that the post-processing unit 401 is connected to the printer 102, the MPU 802 may determine whether post-processing, such as stapling or sorting, of the post-processing unit 401 is specified to be performed. Then, according to this determination, the MPU 802 may change the process to be subsequently performed. An instruction for performing post-processing, such as stapling or sorting, from the user can be received via the operation unit of the host computer 101. Then, from the CPU 703, the MPU 802 receives information as to whether post-processing is to be performed and makes a determination on the basis of the received information.

For example, after it is determined in step S501 of FIG. 14 or FIG. 15 that the post-processing unit 401 is connected to the printer 102, the MPU 802 makes another determination as to whether post-processing of the post-processing unit 401 is to be performed. If post-processing is specified to be performed, the process proceeds to step S502. If post-processing is not specified to be performed, the process proceeds to step S509. Thus, sheet reciprocation is performed only when post-processing is specified to be performed. That is, productivity can be maintained when post-processing is not specified to be performed.

### Seventh Exemplary Embodiment

In the embodiments described above, the printer 102 is provided with the post-processing unit 401. However, the present invention is applicable even when the printer 102 is not provided with the post-processing unit 401.

For example, if the post-processing unit 401 is not connected to the printer 102, a function similar to that of the conveying rollers 71 described in the above embodiments may be carried out by the ejection rollers 21. Here, control may be performed such that a function similar to that of the sheet sensor 817 is carried out by a sensor (not shown) provided at a position indicated by reference numeral 42 of FIG. 4. Additionally, a determination as to whether ejection of a sheet has been completed may be made depending on whether a predetermined time has elapsed after feeding of the sheet. If, with this configuration, sheet reciprocation is performed with respect to each page, ejected sheets can be prevented from sticking together even if the post-processing unit 401 is not provided.

### Other Exemplary Embodiments

Although a laser-beam printer has been described as an example of the printer 102 in the embodiments described above, the present invention is not limited to this. The printer 102 may be an ink-jet printer or other types of printers. These printers use ink or other liquids as the recording material and so do not require a fixing unit. However, these printers still have a requirement for the ink or other liquid deposited on the sheet to be dry or stable before the sheet comes into contact with another sheet. Also, in the embodiments described above, some part of the sheet conveying mechanism (the conveying rollers 21) is used to bring about the required movement of the sheet for drying purposes. This is cost-efficient because the conveying mechanism has to be provided anyway. However, it is not necessary to do this. The movement of the sheet to dry the recording material need not be reciprocal movement. Any form of agitation of the sheet is possible as long as it brings about drying of the sheet, or stabilization of the recording material, prior to the operation (stacking etc.) in which problems could otherwise occur. Such agitation could be brought about by vibration of the sheet in a direction perpendicular to its main plane or parallel to its main plane (e.g. perpendicular to the normal conveying direction). Such agitation could also be brought about by rotating the sheet.

The printer 102 having no fan has been described in the embodiments described above. However, the printer 102 may be one having a fan and performing control similar to that described in the above embodiments. In the latter case, even without using a fan, sheets can be prevented from sticking together due to toner fusion.

Next, with reference to a memory map of FIG. 19, there will be described a configuration of a data processing program readable by the image forming apparatus according to an embodiment the present invention.

FIG. 19 illustrates a memory map of a storage medium that stores various data processing programs readable by the image forming apparatus according to an embodiment of the present invention.

Although not specifically shown, information, such as version information and creator names, for managing program groups stored in the storage medium is also stored. Additionally, information, such as icons for identification of programs, dependent on an operating system (OS) reading the programs may be stored.

Data dependent on various programs is stored in a directory where the programs are stored. Moreover, programs for installing various programs on a computer and programs for decompressing compressed programs to be installed may also be stored.

The functions of the above-described embodiments illustrated in the drawings may be implemented when the host computer 101 executes an externally installed program. In this case, the host computer 101 is configured such that data for displaying an operation screen is externally installed and various user interface screens are displayed on a display unit of the host computer 101. In this configuration, the present invention is also applicable to the case where an information group including the program is supplied to an output apparatus from a storage medium, such as a compact-disk read-only memory (CD-ROM), a flash memory, or a floppy disk (FD) or from an external storage medium via a network.

The present invention can be implemented when a storage medium storing software program code for realizing the functions of the above-described embodiments is supplied to a system or an apparatus and a computer (e.g., CPU or MPU) of the system or apparatus reads and executes the software program code stored in the storage medium.

In this case, the software program code read from the storage medium realizes the novel functions of the present invention. That is, a computer-readable storage medium storing the software program code constitutes the present invention.

Here, the program may take any form as long as it serves as a program. Examples of possible forms of the program include object code, a program executed by an interpreter, and script data supplied to an OS.

Examples of the storage medium for supplying the program include a flexible disk, a hard disk, an optical disk, a magneto-optical (MO) disk, a CD-ROM, a CD-recordable (CD-R), a CD-rewritable (CD-RW), a magnetic tape, a nonvolatile memory card, a ROM, and a digital versatile disk (DVD).

The program may be downloaded from an Internet homepage using a browser on a client computer. That is, the computer program of the present invention or a file created by compressing the program and having an automatic installation function may be downloaded from the homepage to a recording medium, such as a HDD. Alternatively, the program code included in the program of the present invention may be divided into a plurality of files, which are then downloaded from different homepages. Therefore, a World Wide Web (WWW) server and an ftp server which allow a plurality of users to download program files for realizing the functions and processes of the present invention may also constitute the present invention.

The program of the present invention may be encrypted, stored in a storage medium, such as a CD-ROM, and distributed to users. In this case, only users who satisfy predetermined conditions may be allowed to download key information for decrypting the encrypted program from a homepage via the Internet. Then, the users decrypt the encrypted program using the key information, execute the decrypted program, and install the program on a computer to implement the program.

The functions of the above-described embodiments are performed when a computer reads and executes the program code. Alternatively, according to instructions of the program code, an OS running on the computer may carry out all or part of the actual process. This also allows the functions of the above-described embodiments to be performed.

The functions of the above-described embodiments may be performed when the program code read out of a storage medium is written to a function expansion board in a computer or to a memory of a function expansion unit connected to a computer and then, according to instructions of the program code, the function expansion board or a CPU in the function expansion unit carries out all or part of the actual process.

The present invention is applicable to either a system constituted by a plurality of devices or an apparatus constituted by a single device. It is to be understood that the present invention is also applicable to a case where the present invention is achieved by supplying the program to the system or apparatus. In this case, the system or apparatus can obtain the effects of the present invention by reading a storage medium storing the program represented by software for achieving the present invention.

The present invention is not limited to the embodiments described above. Various modifications (including organic combinations of the above-described embodiments) can be made on the basis of the spirit of the present invention and are not excluded from the scope of the present invention. For example, although the various control operations described above are performed primarily by the CPU of the image forming apparatus in the above-described embodiments, all or some of the various control operations may be performed by an external controller included in an external apparatus having a housing independent of that of the image forming apparatus.

The present invention has been described with reference to various examples and embodiments. However, it is to be understood that the spirit and scope of invention are not limited to a specific description in the present specification.

This application claims the benefit of Japanese Application No. 2007-226334 filed Aug. 31, 2007, which is hereby incorporated by reference herein in its entirety.

What is claimed is:

1. An image forming apparatus comprising:
a fixing unit configured to fix recording material on a sheet;
a conveying unit configured to convey the sheet on which the recording material is fixed by the fixing unit; and
a control unit configured to control the conveying unit such that the conveying unit reciprocates the sheet on a conveying path along which the sheet is conveyed.

2. The image forming apparatus according to claim 1, wherein the control unit controls the conveying unit such that the conveying unit reciprocates the sheet on the conveying path when a predetermined condition is satisfied.

3. The image forming apparatus according to claim 1, further comprising:
an image forming unit configured to form an image on the sheet with the recording material; and
a detecting unit configured to detect the amount of recording material used by the image forming unit to form the image,
wherein the control unit controls the conveying unit such that the conveying unit reciprocates the sheet on the conveying path when the detecting unit detects that the amount of recording material used is greater than a predetermined value.

4. The image forming apparatus according to claim 3, wherein the detecting unit detects the amount of recording material used by the image forming unit for image formation in a partial region of the sheet; and
the control unit controls the conveying unit such that the conveying unit reciprocates the sheet on the conveying path when the detecting unit detects that the amount of recording material used for image formation in the partial region of the sheet is greater than a predetermined value.

5. The image forming apparatus according to claim 1, further comprising a temperature detecting unit configured to detect a temperature,
wherein the control unit controls the conveying unit such that the conveying unit reciprocates the sheet on the conveying path when the temperature detecting unit detects that the temperature is higher than a predetermined value.

6. The image forming apparatus according to claim 5, further comprising an outputting unit configured to output the sheet,
wherein the temperature detected by the temperature detecting unit is a temperature near the outputting unit.

7. The image forming apparatus according to claim 1, further comprising a post-processing unit configured to perform post-processing on the sheet,
wherein the control unit controls the conveying unit such that the conveying unit reciprocates the sheet on the conveying path when the post-processing is to be performed on the sheet by the post-processing unit.

8. The image forming apparatus according to claim 7, wherein the post-processing is stapling or sorting.

9. A control method for controlling an image forming apparatus, the control method comprising:
fixing recording material on a sheet;
conveying, by a conveying unit, the sheet on which the recording material is fixed; and
controlling the conveying unit such that the conveying unit reciprocates the sheet on a conveying path along which the sheet is conveyed.

10. The control method according to claim 9, wherein the conveying unit is controlled such that the conveying unit reciprocates the sheet on the conveying path when a predetermined condition is satisfied.

11. The control method according to claim 9, further comprising:
forming an image on the sheet with the recording material; and
detecting the amount of recording material used to form the image,
wherein the conveying unit is controlled such that the conveying unit reciprocates the sheet on the conveying path when it is detected that the amount of recording material used is greater than a predetermined value.

12. The control method according to claim 11, wherein the amount of recording material used for image formation in a partial region of the sheet is detected; and
the conveying unit is controlled such that the conveying unit reciprocates the sheet on the conveying path when it is detected that the amount of recording material used for image formation in the partial region of the sheet is greater than a predetermined value.

13. The control method according to claim 10, further comprising detecting a temperature,
wherein the conveying unit is controlled such that the conveying unit reciprocates the sheet on the conveying path when it is detected that the temperature is higher than a predetermined value.

14. The control method according to claim 13, further comprising outputting the sheet on an ejection unit,
wherein the detected temperature is a temperature near the ejection unit.

15. The control method according to claim 10, further comprising performing post-processing on the sheet,
wherein the conveying unit is controlled such that the conveying unit reciprocates the sheet on the conveying path when the post-processing is to be performed on the sheet.

16. The control method according to claim 15, wherein the post-processing is stapling or sorting.

17. A computer readable medium containing computer-executable instructions for controlling an image forming apparatus, the medium comprising:
computer-executable instructions for causing a fixing unit to fix recording material on a sheet;
computer-executable instructions for causing a conveying unit to convey the sheet on which the recording material is fixed; and
computer-executable instructions for controlling the conveying unit such that the conveying unit reciprocates the sheet on a conveying path along which the sheet is conveyed.

18. An image forming apparatus comprising:
an image forming unit configured to employ recording material to form an image on a sheet;
an operation unit configured to receive such a sheet after such an image has been formed on the sheet by the image forming unit, and to perform a predetermined operation on the received sheet; and
an agitation unit configured to agitate the sheet prior to the performance of the predetermined operation on the sheet by the operation unit.

19. The image forming apparatus according to claim 18, wherein the agitation of the sheet involves moving the sheet in at least one direction other than a normal conveyance direction of the sheet.

20. The image forming apparatus according to claim 18, wherein the agitation of the sheet involves moving the sheet reciprocally.

21. The image forming apparatus according to claim 18, having sheet conveying unit configured to, after such an image has been formed on such a sheet by the image forming unit, convey the sheet to the operation unit, wherein the agitation unit is operable to employ the sheet conveying unit to bring about at least part of the agitation of the sheet.

22. The image forming apparatus according to claim 18, wherein the agitation unit is operable to carry out the agitation of the sheet when one or more predetermined conditions are satisfied.

23. The image forming apparatus according to claim 22, wherein the or one said condition is that an amount of recording material included in the image formed on the sheet, or included in a preselected region of that image, exceeds a predetermined threshold value.

24. The image forming apparatus according to claim 22, wherein the or one said condition is that a temperature of the sheet, or a temperature in a part of the apparatus in which the sheet will be accommodated when the predetermined operation is performed, exceeds a predetermined threshold value.

25. The image forming apparatus according to claim 18, wherein the predetermined operation is an operation in which the sheet will come into contact with another sheet.

26. An image forming method comprising:
employing recording material to form an image on a sheet;
receiving such a sheet after such an image has been formed on the sheet, and performing a predetermined operation on the received sheet; and
agitating the sheet prior to the performance of the predetermined operation on the sheet.
